(19) United States
(12) Patent Application Publication
(10) Pub. No.: US 2021/0118140 A1
(43) Pub. Date: Apr. 22, 2021

(54) DEEP MODEL TRAINING METHOD AND APPARATUS, ELECTRONIC DEVICE, AND STORAGE MEDIUM

(71) Applicant: BEIJING SENSETIME TECHNOLOGY DEVELOPMENT CO., LTD., Beijing (CN)

(72) Inventor: Jiahui LI, Beijing (CN)

(21) Appl. No.: 17/136,072

(22) Filed: Dec. 29, 2020

Related U.S. Application Data
(63) Continuation of application No. PCT/CN2019/114493, filed on Oct. 30, 2019.

(30) Foreign Application Priority Data
Dec. 29, 2018 (CN) 201811646430.5

(51) Int. Cl. G06T 7/10; G06F 40/169

(52) U.S. Cl. CPC G06T 7/10; G06T 2207/20081; G06F 40/169

(57) ABSTRACT

A method for training a deep learning model includes: obtaining (n+1)th annotation information output by a model to be trained, wherein the model to be trained has undergone n rounds of training, where n is an integer greater than or equal to 1; generating an (n+1)th training sample based on training data and the (n+)th annotation information; and performing an (n+1)th round of training on the model to be trained using the (n+1)th training sample.

### CROSS-REFERENCE TO RELATED APPLICATIONS

This application is a continuation of International Patent Application PCT/CN2019/114493, filed on Oct. 30, 2019, which claims priority to Chinese Patent Application No. 201811646430.5, filed on Dec. 29, 2018. The disclosures of International Patent Application PCT/CN2019/114493 and Chinese Patent Application No. 201811646430.5 are hereby incorporated by reference in their entireties.

### BACKGROUND

A deep learning model may have certain classification or recognition capabilities after being trained through a training set. The training set generally includes training data and annotation data of the training data. However, in general, annotation data is obtained through annotating the data manually. Annotating all the training data purely by hand is a heavy workload with low efficiency, and manual errors exist in the annotation process. Besides, if high-accuracy annotation such as annotations in the image field is required, it is required to achieve pixel-level segmentation. However, it is very difficult to achieve pixel-level segmentation and to guarantee annotation accuracy by means of pure manual annotation.

Therefore, the training of the deep learning model based on pure manually-annotated training data will have low training efficiency, and the accuracy of classification or recognition of the model obtained through the training will not reach the expectation due to the low accuracy of the training data itself.

### SUMMARY

The present disclosure generally relates to, but is not limited to, the field of information technology, and more particularly to a method and an apparatus for training a deep model, an electronic device and a storage medium.

The technical solutions of the present disclosure are implemented as follows.

A first aspect of the embodiments of the present disclosure provides a method for training a deep learning model, including: obtaining (n+1)th annotation information output by a model to be trained, herein the model to be trained has undergone n rounds of training, where n is an integer greater than or equal to 1; generating an (n+1)th training sample based on training data and the (n+1)th annotation information; and performing an (n+1)th round of training on the model to be trained using the (n+1)th training sample.

A second aspect of the embodiments of the present disclosure provides an apparatus for training a deep learning model, including: a memory storing processor-executable instructions; and a processor configured to execute the stored processor-executable instructions to perform operations of: obtaining (n+1)th annotation information output by a model to be trained, wherein the model to be trained has undergone n rounds of training, where n is an integer greater than or equal to 1; generating an (n+1)th training sample based on training data and the (n+1)th annotation information; and performing an (n+1)th round of training on the model to be trained using the (n+1)th training sample.

A third aspect of the embodiments of the present disclosure provides a non-transitory computer storage medium having stored thereon computer executable instructions that, when executed by a processor, cause the processor to perform a method for training a deep learning model, the method including: obtaining (n+1)th annotation information output by a model to be trained, wherein the model to be trained has undergone n rounds of training, where n is an integer greater than or equal to 1: generating an (n+1)th training sample based on training data and the (n+1)th annotation information; and performing an (n+)th round of training on the model to be trained using the (n+1)th training sample.

### BRIEF DESCRIPTION OF THE DRAWINGS

FIG. 1 is a schematic flowchart of a first method for training a deep learning model provided by an embodiment of the present disclosure:

FIG. 2 is a schematic flowchart of a second method for training a deep learning model provided by an embodiment of the present disclosure;

FIG. 3 is a schematic flowchart of a third method for training a deep learning model provided by an embodiment of the present disclosure:

FIG. 4 is a schematic structural diagram of an apparatus for training a deep learning model provided by an embodiment of the present disclosure;

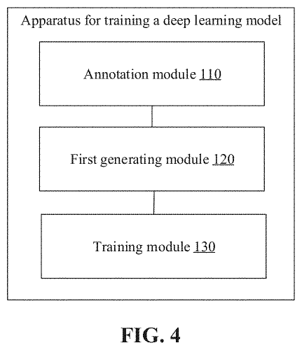

FIG. 5 is a schematic diagram of changes in a training set provided by an embodiment of the present disclosure; and

FIG. 6 is a schematic structural diagram of an electronic device provided by an embodiment of the present disclosure.

### DETAILED DESCRIPTION

The technical solutions of the present disclosure will be further described in detail below in conjunction with the drawings and specific embodiments of the specification.

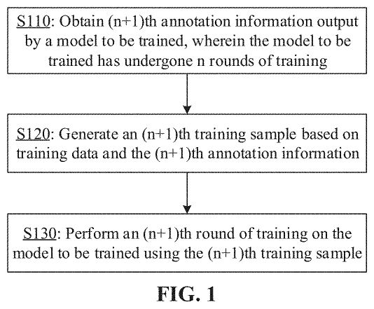

As shown in FIG. 1, this embodiment provides a method for training a deep learning model, including the following operations.

In S110, (n+1)th annotation information output by a model to be trained is obtained, herein the model to be trained has undergone n rounds of training.

In S120, an (n+1)th training sample is generated based on training data and the (n+1)th annotation information.

In S130, the (n+1)th round of training is performed on the model to be trained using the (n+1)th training sample.

The method for training a deep learning model provided in this embodiment may be used in various electronic devices, for example, servers used for various big data model training.

In the first round of training, a model structure of a model to be trained is obtained. Taking a model to be trained being a neural network as an example, the network structure of the neural network needs to be figured out first. The network structure may include: the number of layers of the network, the number of nodes included in each layer, the connection relationship of the nodes among layers and the initial network parameters. The network parameters include: a weight and/or a threshold of the node.

A first training sample is obtained, the first training sample may include: training data and first annotation data of the training data. Taking image segmentation as an example, the training data is an image, and the first annotation data may be a masked image of the segmentation object and the background in the image. In the embodiments of the present disclosure, all first annotation information and second annotation information may include, but are not limited to, annotation information of the image. The image may include medical images and the like. The medical image may be a plane (2D) medical image or a stereo (3D) medical image composed of an image sequence formed by multiple 2D images. Each of the first annotation information and the second annotation information may be annotations of an organ and/or a tissue in a medical image, or annotations of different cell structures in a cell, such as annotations of a cell nucleus. In some embodiments, the image is not limited to medical images, and can also be images of traffic road conditions when the method is applied in the field of traffic roads.

The first training sample is used to perform a first round of training on the model to be trained. After a deep learning model such as a neural network is trained, the model parameters of the deep learning model (for example, network parameters of the neural network) are changed. The model to be trained with the changed model parameters is used to process the image and output the annotation information. The annotation information is compared with the initial first annotation information, and the current loss value of the deep learning model is calculated based on the result of the comparison. If the current loss value is less than the loss threshold, this round of training can be stopped.

In S110 of the embodiment, the model to be trained that has completed n rounds of training is used to process the training data. Then, the model to be trained will obtain an output, which is the (n+1)th annotation data. A training sample is formed by associating the (n+1)th annotation data with the training data.

In some embodiments, the training data and the (n+1)th annotation information may be directly used as the (n+1)th training sample which is used as the training sample of the (n+1)th round of training of the model to be trained.

In some other embodiments, the training data, the (n+11)th annotation data, and the first training sample may be combined to form the training sample of the (n+1)th round of training of the model to be trained.

The first training sample is a training sample used to perform the first round of training on the model to be trained; the Mth training sample is a training sample used to perform the Mth round of training on the model to be trained, where M is a positive integer.

The first training sample here may be the training data obtained initially and the first annotation information of the training data, herein the first annotation information may be manually-annotated information.

In some other embodiments, the (n+1)th training sample may be the union of the nth training sample used in the nth round of training and a training sample generated based on the training data and the (n+1)th annotation information.

In short, the above three methods for generating the (n+1)th training sample are all methods of automatically generating samples by the device. In this way, there is no need to obtain the training sample of the (n+1)th round of training by means of the manual annotation or annotation made by other devices. Therefore, the time spent for annotating the samples initially, such as manual annotation, is reduced and the speed for training the deep learning model is increased. Furthermore, the phenomena of the inaccuracy of classification or recognition results of the deep learning model after being trained due to inaccuracy caused by the manual annotation is reduced, and the accuracy of classification or recognition results of the deep learning model after being trained is increased.

Completing a round of training in this embodiment includes: the model to be trained has completed learning on each training sample in the training set at least once.

In S130, the (n+1)th training sample is used to perform the (n+1)th round of training on the model to be trained.

In this embodiment, if there are a few errors in the initial annotation, since the common characteristics of the training samples will be paid attention to during the model training process, the impact of these errors on the model training will become smaller and smaller, and the accuracy of the model will become increasingly high.

For example, taking the training data being S images as an example, the first training sample may be S images and the result of manual annotation of these S images. If the accuracy of the annotation of one of the S images is not sufficient, but in the process of first round of training of the model to be trained, since the accuracy of the annotation of the remaining S−1 images reaches the expected threshold, the S−1 images and annotation data corresponding to the S−1 images have larger impact on the model parameters of the model to be trained. In this embodiment, the deep learning model includes, but is not limited to, a neural network, and the model parameters include, but are not limited to, a weight and/or a threshold of each network node in the neural network. The neural network may be various types of neural networks, for example, a U-net or a V-net. The neural network may include an encoding part performing feature extraction on the training data and a decoding part obtaining semantic information based on extracted features.

For example, the encoding part may perform feature extraction on a region where the segmentation object is located in the image, to obtain a masked image that distinguishes the segmentation object from the background. Based on the masked image, the decoder may obtain some semantic information, for example, omics features of the object obtained through pixel statistics, etc.

The omics features may include morphological features such as the area, volume and shape of the object, and/or gray value features formed based on the gray value.

The gray value features may include statistical characteristics of a histogram and the like.

In short, in this embodiment, when the model to be trained having undergone a first round of training recognizes S images, an image with insufficiently accurate initial annotation will have less impact on model parameters of the model to be trained than the impact made by other S−1 images. The model to be trained will use network parameters learned from other S−1 images for performing annotation. At this time, the accuracy of the annotation of the image with the insufficiently accurate initial annotation is getting closer to the accuracy of the annotation of other S−1 images, so the second annotation information corresponding to the image with the insufficiently accurate initial annotation is more accurate than the original first annotation information. In this way, the constructed second training set includes: training data composed of S images and the original first annotation information, and training data composed of S images and the second annotation information annotated by the model to be trained itself. Therefore, in this embodiment, the negative effect of the training sample with insufficiently accurate or incorrect initial annotation will be gradually suppressed by utilizing the capability of the model to be trained to learn based on most correct or high-accurate annotation information during the training process. Thus, by adopting such a way to perform automatic iteration of the deep learning model, the manual annotation of training sample is greatly reduced, and the accuracy of the training is gradually improved through self-iteration, making the accuracy of the model to be trained after being trained achieve an expected effect.

In the above examples, images are taken as the training data. In some embodiments, the training data may also be audio clips or text information other than the images, etc. In short, the training data has many forms and is not limited to any of the above.

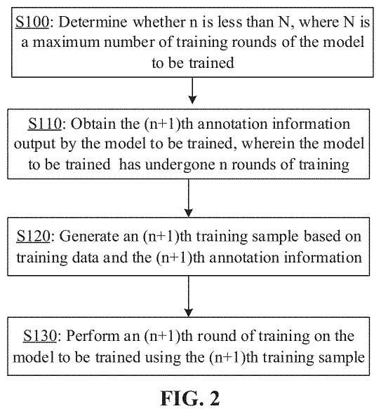

In some embodiments, as shown in FIG. 2, the method includes:

In S100, whether n is less than N is determined, where N is the maximum number of training rounds of the model to be trained,

the S110 further include:

responsive to n being less than N, the model to be trained obtains (n+1)th annotation information output by the model to be trained.

In this embodiment, before constructing an (n+1)th training set, whether or not the number of training rounds of the current model to be trained reaches the predetermined maximum number of training rounds N will be determined. If not, the (n+1)th annotation information is generated to construct the (n+1)th training set. Otherwise, it is determined that the model training has been completed and the training of the deep learning model is stopped.

In some embodiments, the value of N may be an empirical value or a statistical value such as 4, 5, 6, 7 or 8.

In some embodiments, the value range of N may be between 3 and 10, and the value of N may be a user input value received by a training device from a human-computer interaction interface.

In some other embodiments, determining whether to stop the training of the model to be trained may further include the following operations.

A test set is used to test the model to be trained. If the test result shows that the accuracy of the annotation result of the test data in the test set made by the model to be trained reaches a certain value, the training of the model to be trained is stopped, otherwise S10 is performed to enter the next round of training. At this time, the test set may be a accurately annotated data set, so the test set may be used to measure the training result of each round of training of a model to be trained to determine whether to stop the training of the model to be trained.

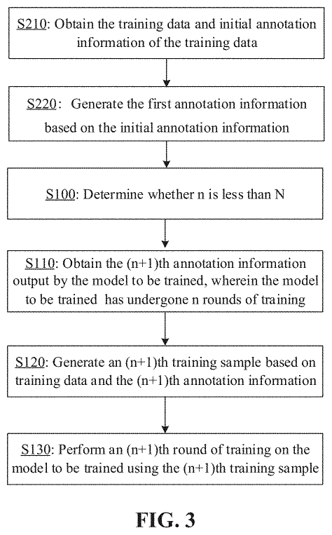

In some embodiments, as shown in FIG. 3, the method includes following operations.

In S210, the training data and initial annotation information of the training data are obtained.

In S220, the first annotation information is generated based on the initial annotation information.

In this embodiment, the initial annotation information may be the original annotation information of the training data. The original annotation information may be manually-annotated information or information annotated by other devices. For example, information annotated by other devices capable of performing annotation.

In this embodiment, after the training data and the initial annotation information are obtained, first annotation information is generated based on the initial annotation information. The first annotation information here may directly include the initial annotation information and/or refined first annotation information generated according to the initial annotation information.

For example, if the training data is an image and the image contains a cell image, the initial annotation information may be annotation information that roughly annotates the location of the cell image, while the first annotation information may be annotation information that accurately indicates the location of the cell. In short, in this embodiment, the accuracy of the annotation of the first annotation information on the segmented object may be higher than the accuracy of the initial annotation information.

In this way, even if the initial annotation information is annotated manually, the difficulty of manual annotation is reduced, and the manual annotation is simplified.

For example, taking a cell image as an example, due to the shape of a cell being an ellipsoid, the outer contour of the cell in a two-dimensional plane image is generally elliptical. The initial annotation information may be a bounding box of the cell manually drawn by a doctor. The first annotation information may be an inscribed ellipse generated by a training device based on the manually-annotated bounding box. Compared with the bounding box, the inscribed ellipse has a reduced number of pixels in the cell image that do not belong to the cell image, thus the accuracy of the first annotation information is higher than the accuracy of the initial annotation information.

Therefore, the S210 may further include: acquiring a training image containing multiple segmentation objects and a bounding box of each segmentation object.

The S220 may include: drawing, within the bounding box, an annotation contour consistent with a shape of the segmentation object based on the bounding box.

In some embodiments, the annotation contour consistent with the shape of the segmentation object may be the aforementioned ellipse but is not limited to the ellipse. For example, it may also be a circle, a triangle or other diagonal shapes that are equal to the shape of the segmentation object.

In some embodiments, the annotation contour is inscribed in the bounding box. The bounding box may be a rectangular box.

In some embodiments, the S220 further includes:

generating a segmentation boundary of two of the segmentation objects based on bounding boxes of the segmentation objects, the two segmentation objects having an overlapping part.

In some images, two segmentation objects may overlap. In this embodiment, the first annotation information further includes a segmentation boundary between the two overlapping segmentation objects.

For example, there are two cell images A and B, and the cell image A is superimposed on the cell image B. After the cell boundary of the cell image A is drawn and the cell boundary of cell image B is drawn, the part formed by two crossed cell boundaries outlines the intersection between these two cell images. In this embodiment, according to the positional relationship between the cell image A and the cell image B, the part of the cell boundary of the cell image B located inside the cell image A may be erased, and the part of the cell boundary of the cell image A, which is located inside the cell image B, is taken as the segmentation boundary.

In short, in this embodiment, the S220 may include: drawing a segmentation boundary on the overlapping part of the two segmentation objects by utilizing the positional relationship of these two segmentation objects.

In some embodiments, drawing a segmentation boundary may be completed by modifying the boundary of one of the two segmentation objects with overlapping boundaries. In order to emphasize the boundary, the boundary may be thickened by means of pixel expansion. For example, expanding the cell boundary of the cell image A by a predetermined number of pixels, such as one or multiple pixels in a direction from the overlapping part towards the cell image B, the boundary of the cell image A of the overlapping part is thickened, so that the thickened boundary is recognized as the segmentation boundary.

In some embodiments, drawing, within the bounding box, the annotation contour consistent with the shape of the segmentation object based on the bounding box includes: drawing, within the bounding box, an inscribed ellipse of the bounding box consistent with a shape of a cell based on the bounding box.

In this embodiment, the segmentation object is a cell image, and the annotation contour includes an inscribed ellipse of the bounding box consistent with a shape of a cell.

In this embodiment, the first annotation information includes at least one of:

a cell boundary of the cell image (corresponding to the inscribed ellipse), and

a segmentation boundary between the overlapped cell image.

If, in some embodiments, the segmentation object is not a cell but other objects, for example, the segmentation object may be faces in a group photo, the bounding box of the face may still be a rectangular box, but the annotation boundary of the face may be a boundary of an oval face, a boundary of a round face, etc. At this time, the shape is not limited to the inscribed ellipse.

Of course, the above are only examples. In short, in this embodiment, the model to be trained outputs, during its own training process, annotation information of the training data by utilizing its previous round of training result, to construct the next round of training set. Model training is completed through multiple repeated iterations without annotating a large number of training samples manually, which has a fast training rate and may improve accuracy of the training through repeated iterations.

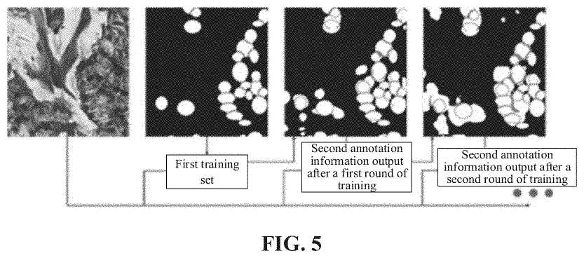

As shown in FIG. 5, this embodiment provides an apparatus for training a deep learning model, the apparatus including:

an annotation module 110, configured to obtain (n+1)th annotation information output by a model to be trained, herein the model to be trained has undergone n rounds of training, where n is an integer greater than or equal to 1;

a first generating module 120, configured to generate an (n+)th training sample based on training data and the (n+1)th annotation information; and

a training module 130, configured to perform an (n+1)th round of training on the model to be trained using the (n+1)th training sample.

In some embodiments, the annotation module 110, the first generating module 120 and the training module 130 may be a program module. When being executed by the processor, the program module may achieve the generation of the (n+1)th annotation information, the composition of the (n+1)th training set and the training of the model to be trained.

In some other embodiments, the annotation module 110, the first generating module 120 and the training module 130 may be a model combining software and hardware; the model combining software and hardware may be various programmable arrays, for example, a field programmable array or complex programmable array.

In other embodiments, the annotation module 110, the first generating module 120, and the training module 130 may be a pure hardware module, and the pure hardware module may be application-specific integrated circuits.

In some embodiments, the first generating module 120 is configured to generate the (n+1)th training sample based on the training data, the (n+1)th annotation information and a first training sample; or generate the (n+1)th training sample based on the training data, the (n+1)th annotation information and an nth training sample, where the nth training sample includes: a first training sample composed of the training data and first annotation information, and a second training sample to an (n−1)th training sample respectively composed of annotation information obtained through the previous n−1 rounds of training and training samples used in the previous n−1 rounds of training.

In some embodiments, the apparatus includes:

a determining module, configured to determine whether n is less than N, where N is a maximum number of training rounds of the model to be trained,

where the annotation module 110 is configured to, responsive to n being less than N, obtain (n+1)th annotation information output by the model to be trained.

In some embodiments, the apparatus includes:

an obtaining module, configured to obtain the training data and initial annotation information of the training data; and

a second generating module, configured to generate the first annotation information based on the initial annotation information.

In some embodiments, the obtaining module is configured to obtain a training image containing multiple segmentation objects and a bounding box of each segmentation object,

herein generating the first annotation information based on the initial annotation information includes:

drawing, within the bounding box, an annotation contour consistent with a shape of the segmentation object based on the bounding box.

In some embodiments, the first generating module 120 is configured to generate a segmentation boundary of two of the segmentation objects based on bounding boxes of the segmentation objects, the two segmentation objects having an overlapping part.

In some embodiments, the second generating module is configured to draw, within the bounding box, an inscribed ellipse of the bounding box consistent with a shape of a cell based on the bounding box.

A specific example is provided below in conjunction with the foregoing embodiment.

### Example 1

This example provides a self-learning weak-supervised learning method of a deep learning model.

Taking the enclosing rectangular box of each object in FIG. 5 as an input, the pixel segmentation result of the object and other objects that are not annotated may be output through self-learning.

Taking cell segmentation as an example, there are enclosing rectangular annotations of some cells in the image at the beginning. It is observed that most of the cells are ellipses, so the largest inscribed ellipses are drawn in respective rectangles, segmentation lines are drawn between different ellipses, and segmentation lines are drawn on the edge of ellipses. The image and the annotation serve as the initial supervisory signal. The supervisory signal here is the training sample in the training set.

A segmentation model is trained.

Prediction is made by the segmentation model on this image, and a prediction map is obtained, the union of the prediction map and the initial annotation map serves as a new supervisory signal, and then the segmentation model is trained repeatedly.

It is found through observation that the segmentation result in the picture is getting increasingly better.

As shown in FIG. 5, the original image is annotated to obtain a masked image to construct a first training set, and the first training set is used for performing the first round of training. After the training, the deep learning model is used for performing image recognition to obtain second annotation information, and a second training set is constructed based on the second annotation information. After the second round of training is completed using the second training set, third annotation information is output, and a third training set is obtained based on the third annotation information. After multiple rounds of training through repeated iteration, the training is stopped.

In related technologies, the probability map of the first segmentation result needs to be thoroughly studied, peak values, flat areas and the like are analyzed, and then the region growing is made. For readers, the reproduction is of a heavy workload and hard to implement. The method for training a deep learning model provided in this example does not perform any calculation on the output probability map of segmentation, but directly makes a union of the probability map of segmentation and the annotation map, and then continues to training the model. This process is simple to implement.

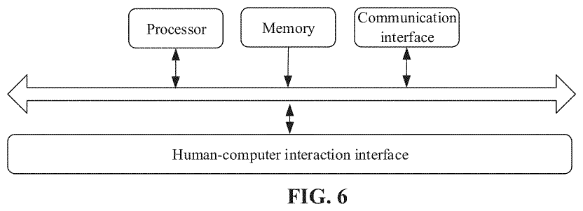

As shown in FIG. 6, an embodiment of the present disclosure provides an electronic device, the electronic device including:

a memory for storing information; and

a processor, connected to the memory and configured to execute computer executable instructions stored in the memory to implement the method for training a deep learning model provided by one or more of the foregoing technical solutions, for example, one or more of the methods shown in FIGS. 1 to 3.

The memory may be various types of memories, such as a random access memory, a read-only memory and a flash memory, etc. The memory may be used for information storage, for example, the memory may be used to store computer executable instructions and the like. The computer executable instructions may be various program instructions, for example, object program instructions and/or source program instructions.

The processor may be various types of processors, for example, a central processing unit, a microprocessor, a digital signal processor, a programmable array, a digital signal processor, an application-specific integrated circuit or an image processor.

The processor may be connected to the memory through a bus. The bus may be an integrated circuit bus or the like.

In some embodiments, the terminal device may further include a communication interface. The communication interface may include a network interface, for example, a local area network interface, a transceiver antenna and the like. The communication interface is also connected to the processor and may be used for information transmission and reception.

In some embodiments, the electronic device further includes a camera, which may collect various images, for example, medical images.

In some embodiments, the terminal device further includes a human-computer interaction interface. For example, the human-computer interaction interface may include various input and output devices, such as a keyboard and a touch screen.

The embodiments of the present disclosure provide a computer storage medium having stored thereon computer executable codes configured to implement, when being executed, the method for training a deep learning model provided by one or more technical solutions, for example, one or more of the methods shown in FIG. 1 to FIG. 3.

The storage medium includes various media capable of storing program codes, such as a mobile storage device, a read-only memory (ROM), a random access memory (RAM), a magnetic disk or an optical disk. The storage medium may be a non-transitory storage medium.

The embodiments of the present disclosure provide a computer program product, the program product includes computer executable instructions configured to implement, when being executed, the method for training a deep learning model provided by any of the foregoing implementations, for example, one or more of the methods as shown in FIG. 1 to FIG. 3.

In the technical solutions provided by the embodiments of the present disclosure, annotation information is obtained by utilizing a deep learning model to annotate training data after a previous round of training is completed, and the annotation information is used as a training sample for a next round of training. A very small amount of initially annotated (for example, initially annotated by hand or devices) training data may be used for performing model training, and then the annotation data recognized and output by the gradually converging model to be trained itself may be used as the next round of training sample. Because model parameters of the model to be trained generated during the previous round of training will be based on the majority of data, which is annotated correctly, while a small amount of data with incorrect annotation or annotation of low accuracy has little impact on the model parameters of the model to be trained, annotation information of the model to be trained becomes more and more accurate and the training results are getting better through repeated iterations. Since the model uses its own annotation information to construct training samples, the amount of data need to be initially annotated such as annotated by hand is reduced, and the manual errors caused by initial annotation such as annotation made by hand is reduced and the efficiency is improved. Besides, a model may be trained at a fast speed and the training effect is good. The deep learning model trained by adopting this method has high accuracy in classification or recognition.

In the several embodiments provided in the present disclosure, it should be understood that the disclosed device and method may be implemented in other ways. The device embodiments described above are merely illustrative. For example, the division of the units is only the division of logical functions, and there may be other divisions in actual implementation, such as: multiple units or components may be combined, or be integrated into another system, or some features can be ignored or not implemented. In addition, the coupling, or direct coupling, or communication connection between the components shown or discussed may be indirect coupling or communication connection between devices or units through some interfaces, and may be electrical, mechanical or other forms.

The units described above as separate components may or may not be physically separate, and the components displayed as units may or may not be physical units, that is, they may be located in one place or distributed on multiple network units. Some or all of the units may be selected according to actual needs to achieve the purpose of the solution of the embodiment.

In addition, the functional units in the embodiments of the present disclosure may be all integrated into one processing module, or each unit may be individually used as a unit, or two or more units can be integrated into one unit. The unit may be implemented in the form of hardware, or in the form of hardware plus software functional units.

An embodiment of the present disclosure discloses a computer program product. The program product includes computer executable instructions configured to implement, when being executed, the method for training a deep model in the foregoing embodiment.

Those of ordinary skill in the art can understand that all or part of the steps in the above method embodiments can be implemented by programs instructing relevant hardware. The foregoing programs can be stored in a computer readable storage medium. The programs execute the operations including the foregoing method embodiment when being executed. The foregoing storage medium includes various medium that can store program codes, such as removable storage devices, read-only memories (ROM), random access memories (RAM), magnetic disks or optical disks, etc.

The above are only specific implementations of the present disclosure, but the protection scope of the present disclosure is not limited thereto. Changes or substitutions that any person skilled in the art can easily think of within the technical scope disclosed in the present disclosure should be covered within the protection scope of the present disclosure. Therefore, the protection scope of the present disclosure should be subject to the protection scope of the claims.

1. A method for training a deep learning model, comprising:
obtaining (n+1)th annotation information output by a model to be trained, wherein the model to be trained has undergone n rounds of training, where n is an integer greater than or equal to 1;
generating an (n+1)th training sample based on training data and the (n+1)th annotation information; and
performing an (n+1)th round of training on the model to be trained using the (n+1)th training sample.

2. The method of claim 1, wherein generating the (n+1)th training sample based on the training data and the (n+1)th annotation information comprises:
generating the (n+1)th training sample based on the training data, the (n+1)th annotation information and a first training sample; or
generating the (n+1)th training sample based on the training data, the (n+1)th annotation information and an nth training sample, wherein the nth training sample comprises: a first training sample composed of the training data and first annotation information, and a second training sample to an (n−1)th training sample respectively composed of annotation information obtained through previous n−1 rounds of training and training samples used in the previous n−1 rounds of training.

3. The method of claim 1, further comprising:
determining whether n is less than N, where N is a maximum number of training rounds of the model to be trained,
wherein obtaining the (n+1)th annotation information output by the model to be trained comprises:
obtaining the (n+1)th annotation information output by the model to be trained, responsive to n being less than N.

4. The method of claim 2, further comprising:
determining whether n is less than N, where N is a maximum number of training rounds of the model to be trained,
wherein obtaining the (n+1)th annotation information output by the model to be trained comprises:
obtaining the (n+1)th annotation information output by the model to be trained, responsive to n being less than N.

5. The method of claim 2, further comprising:
obtaining the training data and initial annotation information of the training data; and
generating the first annotation information based on the initial annotation information.

6. The method of claim 5, wherein obtaining the training data and the initial annotation information of the training data comprises:
obtaining a training image containing multiple segmentation objects and a bounding box of each segmentation object,
wherein generating the first annotation information based on the initial annotation information comprises:
drawing, within the bounding box, an annotation contour consistent with a shape of the segmentation object based on the bounding box.

7. The method of claim 6, wherein generating the first annotation information based on the initial annotation information further comprises:
generating a segmentation boundary of two of the segmentation objects based on bounding boxes of the segmentation objects, the two segmentation objects having an overlapping part.

8. The method of claim 6, wherein drawing, within the bounding box, the annotation contour consistent with the shape of the segmentation object based on the bounding box comprises:
drawing, within the bounding box, an inscribed ellipse of the bounding box consistent with a shape of a cell based on the bounding box.

9. An apparatus for training a deep learning model, comprising:
a memory storing processor-executable instructions; and
a processor configured to execute the stored processor-executable instructions to perform operations of:
obtaining (n+1)th annotation information output by a model to be trained, wherein the model to be trained has undergone n rounds of training, where n is an integer greater than or equal to 1;
generating an (n+1)th training sample based on training data and the (n+1)th annotation information; and
performing an (n+1)th round of training on the model to be trained using the (n+1)th training sample.

10. The apparatus of claim 9, wherein generating the (n+1)th training sample based on the training data and the (n+1)th annotation information comprises:
generating the (n+1)th training sample based on the training data, the (n+1)th annotation information and a first training sample; or
generating the (n+1)th training sample based on the training data, the (n+1)th annotation information and an nth training sample, wherein the nth training sample comprises: a first training sample composed of the training data and first annotation information, and a second training sample to an (n−1)th training sample respectively composed of annotation information obtained through previous n−1 rounds of training and training samples used in the previous n−1 rounds of training.

11. The apparatus of claim 9, wherein the processor is configured to execute the stored processor-executable instructions to further perform an operation of:
determining whether n is less than N, where N is a maximum number of training rounds of the model to be trained,
wherein obtaining the (n+1)th annotation information output by the model to be trained comprises:
responsive to n being less than N, obtaining (n+1)th annotation information output by the model to be trained.

12. The apparatus of claim 10, wherein the processor is configured to execute the stored processor-executable instructions to further perform an operation of:
determining whether n is less than N, where N is a maximum number of training rounds of the model to be trained,
wherein obtaining the (n+1)th annotation information output by the model to be trained comprises:
responsive to n being less than N, obtaining (n+1)th annotation information output by the model to be trained.

13. The apparatus of claim 10, wherein the processor is configured to execute the stored processor-executable instructions to further perform operations of:
obtaining the training data and initial annotation information of the training data; and
generating the first annotation information based on the initial annotation information.

14. The apparatus of claim 13, wherein obtaining the training data and the initial annotation information of the training data comprises:
obtaining a training image containing multiple segmentation objects and a bounding box of each segmentation object,
wherein generating the first annotation information based on the initial annotation information comprises:
drawing, within the bounding box, an annotation contour consistent with a shape of the segmentation object based on the bounding box.

15. The apparatus of claim 14, wherein generating the first annotation information based on the initial annotation information further comprises:
generating a segmentation boundary of two of the segmentation objects based on bounding boxes of the segmentation objects, the two segmentation objects having an overlapping part.

16. The apparatus of claim 14, wherein drawing, within the bounding box, the annotation contour consistent with the shape of the segmentation object based on the bounding box comprises:
drawing, within the bounding box, an inscribed ellipse of the bounding box consistent with a shape of a cell based on the bounding box.

17. A non-transitory computer storage medium having stored thereon computer executable instructions that, when executed by a processor, cause the processor to implement a method for training a deep learning model, the method comprising:
obtaining (n+1)th annotation information output by a model to be trained, wherein the model to be trained has undergone n rounds of training, where n is an integer greater than or equal to 1;
generating an (n+1)th training sample based on training data and the (n+1)th annotation information; and
performing an (n+1)th round of training on the model to be trained using the (n+1)th training sample.

18. The non-transitory computer storage medium of claim 17, wherein generating the (n+1)th training sample based on the training data and the (n+1)th annotation information comprises:
generating the (n+1)th training sample based on the training data, the (n+1)th annotation information and a first training sample; or
generating the (n+1)th training sample based on the training data, the (n+1)th annotation information and an nth training sample, wherein the nth training sample comprises: a first training sample composed of the training data and first annotation information, and a second training sample to an (n−1)th training sample respectively composed of annotation information obtained through previous n−1 rounds of training and training samples used in the previous n−1 rounds of training.

19. The non-transitory computer storage medium of claim 17, wherein the method further comprises:
determining whether n is less than N, where N is a maximum number of training rounds of the model to be trained,
wherein obtaining the (n+1)th annotation information output by the model to be trained comprises:
obtaining the (n+1)th annotation information output by the model to be trained, responsive to n being less than N.

20. The non-transitory computer storage medium of claim 18, wherein the method further comprises:
obtaining the training data and initial annotation information of the training data; and
generating the first annotation information based on the initial annotation information.
